(19) United States
(12) Patent Application Publication
(10) Pub. No.: US 2004/0223082 A1
(43) Pub. Date: Nov. 11, 2004

(54) Process to convert analog and/or standard digital video to broadcast quality high definition video

(76) Inventor: Karl E. Hall, Lewisville, TX (US)

Correspondence Address: Karl E. Hall, Suite 200-D, 4341 Lindbergh Dr., Addison, TX, 75001, US

(21) Appl. No.: 10/429,311

(22) Filed: May 6, 2003

(51) Int. Cl. H04N 11/20

(52) U.S. Cl. 348/441; 348/458

(57) ABSTRACT

This is a unique method to convert analog and/or standard digital video to broadcast quality digital video. The process uses a “frame justification, then clone” horizontal and vertical cloning process converting analog and/or standard digital video to broadcast quality high definition video.

### BACKGROUND OF INVENTION

High definition television is a new technology that will transform the way consumers view television. High definition television delivers high quality video content by adding more clarity, more density and broader dimensions to the television viewing experience. As high definition television becomes the standard for video content, new and old video content developed in analog and standard digital formats will have to be converted into the high definition video format. This patent outlines a process to convert analog/standard digital video formats into high definition video formats.

### SUMMARY OF INVENTION

This document outlines a unique process to convert analog and/or standard digital video to broadcast quality high definition video. This process converts analog and/or standard digital to progressive broadcast quality high definition video with dimensions of 1920 by 1080 pixels.

This process can be executed using personal, server, mini or mainframe computer programs or through a standalone digital apparatus.

This process can also be applied to converting analog and/or standard digital video to other high definition formats using similar process steps.

### BRIEF DESCRIPTION OF DRAWINGS

In FIG. 1, “X” represents scan line pixels and “Y” represents the interlaced scan line pixels in a hypothetical video frame.

In FIG. 2, “U” represents pixels in the new scan line copied over the interlaced line in the hypothetical video frame.

FIG. 3 shows a hypothetical frame from the core video file after it has been inserted into the high definition shell file.

FIG. 4 shows a hypothetical frame where the blank horizontal spaces are cloned from the “X” pixels.

FIG. 5 shows the hypothetical frame after it has been vertically cloned.

### DETAILED DESCRIPTION

### Definitions

Analog Video—6 MHz streaming video conforming to a 520-scan line television picture.

Cloning—Copying a pixel or group of pixels to the next available horizontal and vertical field of data in a frame of a video file.

Encoding—the process of converting analog video files to standard digital video.

High Definition Television—Digital video conforming to 1080 scan lines formatted using a 16:9 dimensional ratio.

Interlacing—Updating of the television picture where only half of the scan lines within a frame are displayed at one time.

Pixel—A small image on a scan line that makes up frames in a video.

Progressive—Updating of the television picture on a frame-by-frame basis where all lines within a frame are displayed.

Standard Digital Video—Digital video that conforms to NTSC and PAL television standards.

### Background

High definition television is a new technology that will transform the way consumers view television. High definition television delivers high quality video content by adding more clarity, more density and broader deminsions to the television viewing experience. As high definition television becomes the standard for video content, new and old video content developed in analog and standard digital formats will have to be converted into the high definition video format. This patent outlines a process to convert analog/standard digital video formats into high definition video formats.

### Introduction

This document outlines a unique process to convert analog and/or standard digital video to broadcast quality high definition video. This process converts analog and/or standard digital to progressive broadcast quality high definition video with dimensions of 1920 by 1080 pixels.

This process can be executed using personal, server, mini or mainframe computer programs or through a standalone digital apparatus.

This process can also be applied to converting analog and/or standard digital video to other high definition formats using similar process steps.

### Video Format

This process may be applied to the following formats:

M-JPEG;

MPEG-1;

Editable MPEG,

MPEG- 2;

MPEG-4;

Real One formats;

Windows Media and Windows ActiveMovie formats; and

Apple QuickTime formats.

This process can also apply to future versions, releases and updates to the above formats.

### Operating Platforms

The process can be executed using the following operating platforms.

Microsoft Windows;

Microsoft Servers;

Unix;

Linux;

Apple Operating Systems; and

Other server, mainframe and personal computer operating platforms.

This process can be applied to future versions, releases and similar operating platforms.

### Applicable Content Media

This process can be applied to the following types of media:

Short films (under 30 minutes in length);

Feature films (over 30 minutes in length);

Animated films (short and feature films);

Broadcast television programming (TV series, commercials, variety shows, reality shows, sporting events, game shows, news broadcasts, talk shows, soap operas/day-time television, music videos, etc.);

Cable television programming (TV series, commercials, variety shows, reality shows, sporting events, game shows, news broadcasts, talk shows, soap operas/day-time television, music videos, etc.);

Wireless cable television programming (TV series, commercials, variety shows, reality shows, sporting events, game shows, news broadcasts, talk shows, soap operas/day-time television, music videos, etc.);

Small dish satellite television programming (TV series, commercials, variety shows, reality shows, sporting events, game shows, news broadcasts, talk shows, soap operas/day-time television, music videos, etc.);

Large dish television programming (TV series, commercials, variety shows, reality shows, sporting events, game shows, news broadcasts, talk shows, soap operas/day-time television, music videos, etc.);

Internet broadcasting (TV series, commercials, variety shows, reality shows, sporting events, game shows, news broadcasts, talk shows, soap operas/day-time television, music videos, etc.); and

Private/Corporate broadcast programming; and-Government broadcast programming.

### Programming Languages

This process can be programmed in the following computer programming languages:-C, C+ and C++;-Pascal and Turbo Pascal;-Java;-Fortran;-SQL;-Perl; and-Other programming languages capable of performing processes outlined within this document.

### Application Process

Process steps 1 through 10 below can be applied one frame at a time or applied to all frames in the video before the next process step is initiated. The latter was used to illustrate process steps 1 through 10 below.

### Conversion Process

The following are steps that may be followed to convert analog and/or standard digital video to broadcast quality high definition video.

Process Step 1

Encode analog video file into standard digital video using an existing encoding platform. This process involved digitizing the composite video signal which containing the color and intensity of each pixel in a set of rows, along with horizontal and vertically synchronized signals that identify how the television set displays the pixels. In addition, the sound is digitized as part of the encoding process. There are numerous video cards, software and stand-alone systems currently on the market that encodes analog video files into standard digital video.

Skip this process step if video is already in a standard digital video format.

Process Step 2

Extract the following information and create three new files: 1. Video information file (header, footer, speed, length of video, dimensions, number of frames, etc.) 2. Core video file (containing frames with only standard video scan lines); and 3. Sound only file.

Process Step 3

Create shell file with high definition (1920 by 1080 pixels, 16:9 dimensional ratio) parameters from information file above.

Process Step 4

Clone all interlaced lines using the primary scan line for each frame within the core video file. The cloning process should scan down the frame and copy the primary scan line (closest scan line from the top) to each interlaced line.

In FIG. 1, “X” represents scan line pixels and “Y” represents the interlaced scan line pixels in a hypothetical video frame.

In FIG. 2, “U” represents pixels in the new scan line copied over the interlaced line in the hypothetical video frame.

Progressive formats do not have to be de-interlaced.

Process Step 5

Insert de-interlaced core video file into the shell file. Next, left, right top and bottom justify scan lines in each frame so that the pixels are spread across the entire shell file. The left, right, top and bottom edges of the new shell file should be smooth.

This process leaves vertical and horizontal spaces within the frame because of the high definition shell file is longer and wider that the core video file.

Process Step 6

For each frame, scan horizontally across each line of pixels one scan line at a time. When a blank space is reached, clone the closest pixel from the left into the blank space on the scan line. Continue this process until you have filled all blank spaces on the scan line. Repeat this process down the frame until all horizontal scan lines are completely filled. Complete this process for each frame in the file. This is process is called horizontal cloning.

Please note that empty scan lines caused by the top and bottom justification should still be blank at this point in the process.

Next, scan each frame vertically until a blank scan line is identified. Clone the closest complete scan line (from the top) into blank scan line. Complete this process for all frames within the video file. This process is called vertical cloning.

At this point, all frames within the video file should have a pixel in every space.

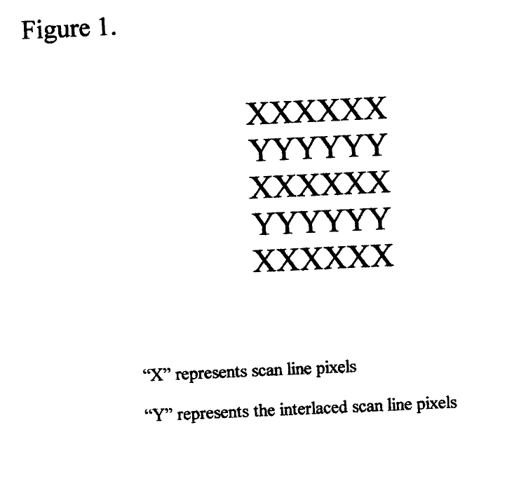

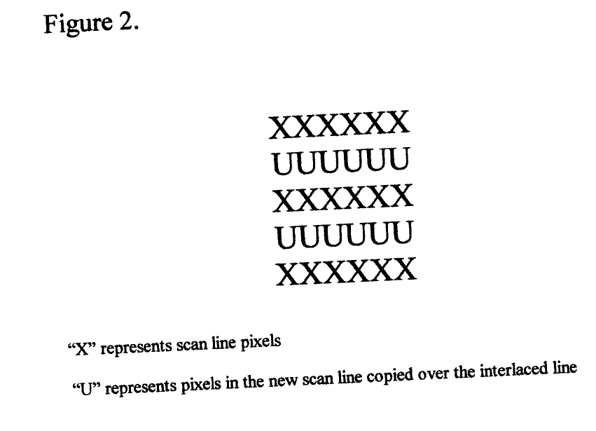

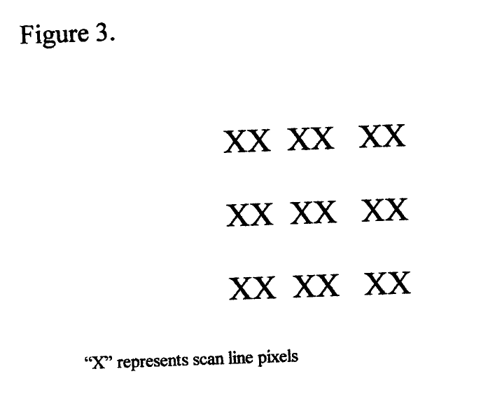

Here is a visual example of the vertical and horizontal cloning process. FIG. 3 shows a hypothetical frame from the core video file after it has been inserted into the high definition shell file. The new file has also been right, left, top and bottom justified. As you can see, there are both vertical and horizontal spaces in the file caused by the justification process.

### Horizontal Cloning Process

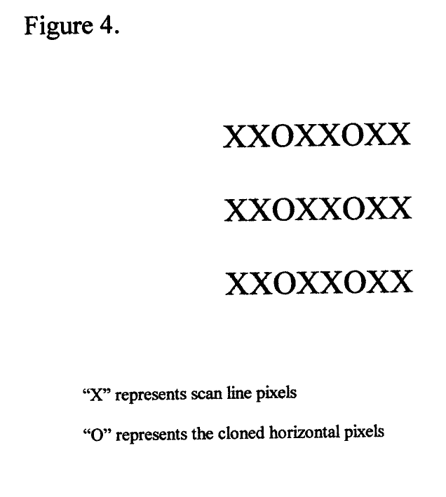

FIG. 4 shows a hypothetical frame where the blank horizontal spaces are cloned from the “X” pixels. “O” represents the cloned horizontal pixels (copied from the closet pixel from the left).

### Vertical Cloning Process

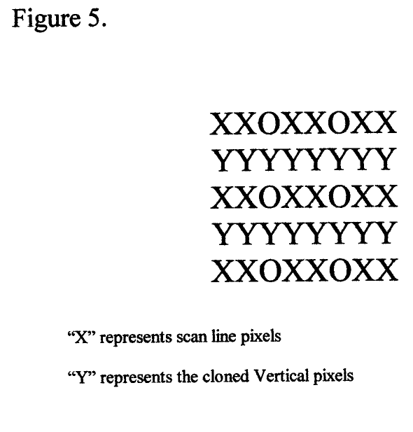

FIG. 5 shows the hypothetical frame after it has been vertically cloned. “Y” represents the cloned vertical pixels copied from the closet full scan line above the blank scan line.

This file is now in high definition format.

Process Step 7

Duplicate each frame within the new high definition video file. This is required to convert high definition video from 30 frames per second to 60 frames per second.

This process step should only be followed for video files that have been de-interlaced.

Process Step 8

Increase the speed of the new high definition video file by 100% to convert the video from 30 frames per second to 60 frames per second.

Process Step 9

Overlay sound within the new high definition video file. Synchronize the sound file using header and footer. Since, the frames were doubled and the speed of the video was increased by 100%, the sound should synchronize as it did prior to the conversion to the high definition format.

Process Step 10

Run a file check to verify bytes, video length and sound synchronization and to make sure there are no blank spaces within the frames of the new high definition video file.

Process Step 11

Rename new high definition video file.

Process Step 12

Compress new high definition video files to reduce overall file size.

This completes the high definition video conversion process.

### Acknowledgements

Microsoft Windows, Windows Media, Windows ActiveMovie and Server are trademarks of the Microsoft Corporation

Apple and QuickTime are trademark of the Apple Computer Company.

Real One is a trademark of Real Networks, Inc.

The Moving Picture Experts Group is commonly known as MPEG.

1. I claim that this is a new and unique process to convert analog video to broadcast quality high definition video.

2. I claim that this is a new and unique process to convert standard digital video to broadcast quality high definition video.

3. I claim that the “frame justification, then clone” horizontal and vertical cloning process is unique to this process of converting analog and/or standard digital video to broadcast quality high definition video.
